(19) United States
(12) Patent Application Publication
(10) Pub. No.: US 2025/0161156 A1
(43) Pub. Date: May 22, 2025

(54) ELECTRIC STOVE

(71) Applicant: LIMITED LIABILITY COMPANY "GRILLD", UFA (RU)

(72) Inventor: SERGEY VLADIMIROVICH SMIRNOV, UFA (RU)

(21) Appl. No.: 18/875,176

(22) PCT Filed: Feb. 10, 2023
(86) PCT No.: PCT/RU2023/050024

§ 371 Date: Dec. 16, 2024

(30) Foreign Application Priority Data
May 16, 2022 (RU) 2022113090

(51) Int. Cl. A61H 33/06; A61H 33/00; F24H 3/00; H05B 3/48

(52) U.S. Cl. CPC A61H 33/063; A61H 33/005; F24H 3/002; H05B 3/48; A61H 2201/0228; A61H 2201/5082; F24H 2250/02

(57) ABSTRACT

An electric stove including a housing having a cover and containing electric heating coils in a convection heater, a rock module with heat-retaining elements, and a convection duct. The convection heater is disposed beneath an enclosed rock compartment, the front wall of the convection heater has convection openings, and the rear part of the convection heater extends into an opening in a rear panel of the convection duct casing. Connected to an opening in the bottom of a pan of an external rock compartment is a connecting pipe, and disposed inside the enclosed rock compartment is a structure consisting of profiled pipes with a series of openings.

### FIELD OF THE INVENTION

The device relates to the field of electrical technology, in particular, to the structure of electric heating device intended for heat and steam generation and which can be used for equipping of baths and saunas.

### BACKGROUND ART

Electric heating devices for baths and saunas “Premiera Rusa 220V with enclosed rock compartment”, “Premiera Rusa 380V with enclosed rock compartment” are known (electric heating devices for baths and saunas, Operating manual, URL: https://vvd.su/pdf/05/03/02-vvd_brosh_pr_rusa_all_compressed.pdf, Electric stoves for bath and sauna/Stoves Premiera/Stove Premiera Rusa 220V (with enclosed rock compartment) URL: https://vvd.su/elektricheskie-pechi-dlya-bani/pechi-premera/premera-rusa-s-zakrytoj-kamenkoj#prettyPhoto), each of which consists of a unit of tubular heating elements (THEs) and the outer enclosure. In the lower part of the device electric heating device there is a terminal block for its connection to a control panel. Sledged rock (gabbro-diabase, soapstone or quartzite) is put inside the electric heating device. Heat storage capacity of electric heating devices is provided by availability of closed and open rock compartments in them. For moistening of air in the steam room, inside the enclosed rock compartment there is a “cup” with a heat accumulator. A small volume of the enclosed rock compartment provides fast heating of heat-retaining elements, but at the same time fast cooling of them in the steam generation mode. It is necessary to obtain an additional steam volume from the rocks in the open rock compartment. Providing a necessary steam generation mode leads to a situation where the temperature of the steam room itself starts to go down due to the decrease of temperature of the heat-retaining elements during steam generation. The process of steam generation and maintaining the temperature in the steam room has a discrete behavior, which leads to reduction of the quality of the obtained steam or reduction of the temperature of the steam room, which in its turn also impacts the quality of steam generation.

Also a device “Electric stove for Russian bath and method of maintaining air temperature in electric furnace in bath steam room” (RU2738678, publication date 15 Dec. 2020, bull. No. 35) is known, which includes insulated furnace housing, electric heaters, heat-retaining elements, temperature sensor of heat-retaining elements. Insulated housing of the furnace is made with a sealed base and side walls fixed on it. Electric heaters are arranged in heated housing of furnace between heat-retaining elements, wherein each electric heater is made in the form of a heat conducting flask, in which a tubular electric heater is fixed. Heat-retaining elements are made in the form of steel rods. In the insulated housing of the furnace there is a ventilation duct for air supply, comprising a fan with a check valve, configured to supply air through air gaps between heat-retaining elements, wherein the fan with the check valve, the temperature sensor of heat-retaining elements and the electric heater are made with possibility of connection to a control unit. Due to blowing of heat-retaining elements and electric heaters by the fan the hot air is delivered in the steam room, during this process electrical heaters are cooled, and the temperature of the heat-retaining elements is reduced. To obtain steam directly from heat-retaining elements an additional heating is required, thus for heating the steam room and the heat-retaining elements more time is required. The process of steam generation and maintaining the temperature in the steam room has a discrete behavior.

A device “Electric oven for steam room of bath” (RU2756610, publication date 4 Oct. 2021, bull. No. 28) is known, which contains a housing with at least one heating element installed in the inner housing with an outlet. An air shell is formed between the housing and the inner housing, which is connected by air channels with the fan discharge outlet and with the cavity of the inner housing; the heating element and the fan are connected to a control unit connected to at least one sensor measuring the temperature in the steam room. In the inner housing there is at least one vent opening, and a temperature sensor connected to the control unit. Between the housing and the inner housing there is a temperature sensor connected to the control unit. The air channel connected to the fan discharge outlet is provided with an outflow mouth, behind which there is an adjustment unit made in the form of a damper and connected to the control unit. A steam generator is a container separated from the main device with an outlet for the steam, with an output pipeline for continuous feeding of water evaporated by tubular heating elements (THE) located inside the steam generator, the level of water is set by a float valve, also in a separate container with a non-sealed cover and connected to the plumbing through a connecting pipe. The air temperature in the steam room is regulated by the fan and the damper, and the steam generator applied for obtaining water stem is used solely for maintaining an optimal ratio of the temperature and the humidity in the steam room, not allowing to create fine-dispersed steam, which can be obtained only at temperature conditions of not less than 500° C. The structure of the device comprises several components with moving and rubbing surfaces and supplementary equipment (floating valve, damper, fan), which fail quicker and require repair and maintenance.

A device “Electric sauna heater with steam generator” (SE500509C2, U.S. Pat. No. 5,054,105A, DE4005793A1) is known comprising at least one electric resistor for heating the sauna room, inside which rocks of the heater can be placed over the resistor, and an evaporator in the form of an evaporating space filled with water, a steam heater, where there is at least one electric resistor for heating water up to the condition of steam, and thermostatic regulators comprising a sensor disposed adjacent to the exterior surface of the evaporating space and responsive to an increase in temperature from a predetermined temperature. Near the evaporator there can be a container for water supply, or water can be fed directly from the plumbing. The evaporator is additionally connected to the steam discharge pipe and a pipe extending close to the top of the sauna heater. The drawback is a complex operation algorithm of the device, which does not allow to provide stability and continuity of temperature conditions and humidity conditions in the steam room, at the same time the structure of the evaporator does not allow to obtain fine-dispersed steam.

A device “Electric stove for baths” (RU2057998) is known, considered as a prototype, which contains a furnace with electric heaters and a chamber connected to it, having heat-retaining load. The housing is formed by a base with a screen and a casing installed coaxially over the base, walls of the screen and the casing form through channels, which are opened in the bottom and in the top are covered by a cover, in the center of which a flexible air- and vapor-permeable heat-resistant mesh is fixed, located in the cavity of the furnace, which is provided with venetian blind windows on its sides. In the cavity of the furnace there are E-configured vertical cups of a heat conductive material, inside which there are electric heaters placed on insulators. The screen prevents from spreading of the heat in sides and collects the heat flow for entering the heat-retaining chamber by the convection flow. The charging chamber of the device is made as a flexible mesh of a heat-resistant material, the air-tight cup is made of heat-resistant steel with a wall of not less than 3 mm thick, and the cup is partially protected by the venetian blinds. In this device only the body of the cup can be sprayed by water, the temperature of which is 450° C. Infrared radiation is transferred to the bodies of the cups, and spreads from them through the volume of the furnace. In the inner cavity of the furnace a convection air flow appears, which passes from the bottom in the channel between the housing of the base and the screen and fills the furnace. Infrared radiation partially heats the screen and is reflected from it back to the center of the furnace, at the same time being added to other heat flows. The temperature of the uprising air flow in the center of the furnace reaches the maximum value. The high-temperature air flow focused in the central part meets obstacles while rising—the chamber, which the flow bypasses on the side, and through the channels between the heat-retaining load the flow penetrates the chamber and uniformly heats the heat-retaining load up to a high temperature. The air having partially given out the heat heats the steam room while going outside. A less heated flow passing in the furnace rises adjacent to the wall of the screen, which are partially heated and give out heat into the channel between the screen and the casing. As a result, heat self-regulating convection flows appear in the channels and heat the steam room of the bath. Once the temperature in the steam room reaches 125° C., the electric stove turns off automatically and remains turned off unless the temperature reduces to 110° C., and then turns on again and the cycle repeats. Once the heat-retaining load reaches the required temperature (380° C.), water is fed to it in portions for obtaining steam. For obtaining dry steam the steam generation process is held during a short time. Once the required temperature in the room is reached, the heat-retaining load may not have enough time to be heated to the temperature required for obtaining dry steam. After feeding water onto the heat-retaining load for obtaining steam, restoration of the temperature necessary for steam generation is required, and this will lead to an excessive increase of the air temperature in the room. The process of steam generation and maintaining the temperature in the steam room has a discrete behavior. Hard infrared radiation may cause burns. The device is provided for an effective obtaining of dry steam in a steam room of 12 m³. Overpassing limits of the ranges decreases efficacy of using as soon as it will lead to generation of wet steam or an excessive increase of power of heaters while increasing the level of danger.

### DISCLOSURE OF THE INVENTION

The problem the present technical solution is intended to solve is improving consumer properties of the device by providing high-temperature heating of heat-retaining elements in an enclosed rock compartment while maintaining a required constant air temperature in the steam room by the convector for obtaining best steam generation conditions.

The result is obtained by the device claimed, which comprises a frame structure with a metal housing in the shape of a regular vertically oriented parallelepiped, in the cover of which a bowl of an external decorative rock compartment with heat-retaining elements of natural rock and a convection grating, through which hot air is supplied to the room, are embedded. The bowl of the external rock compartment is made as a container with walls positioned at an angle to the center of the base of the bowl, in the lower part a connecting pipe of the circular section is sealed to a hole in the bottom of the bowl. Inside the frame structure with a metal housing an enclosed rock compartment module with heat-retaining elements for creating fine-dispersed steam and a convector heater located underneath is installed. A convection duct casing of rectangular cross section is adjacent to the rear wall of the housing, and its upper part extends under the convection grating of the cover of the device. In the outside the device has am assembled decorative facing in the form of tinted heat-resistant glass panels or, for example, decorative panels of stone or brick, which serves for additional protection against infrared radiation of the device.

As heat-retaining elements for open and closed stone compartments sledged or ground natural stones can be used, for example. Besides natural rocks, artificial heat-retaining elements can be used in the enclosed rock compartment, for example, metal ingots of different geometrical shapes, which conform with requirements of resistance to temperature drops, thermal capacity and safety for health.

The enclosed rock compartment module is a metal housing in the shape of a regular vertically oriented parallelepiped with double walls, a bottom and a cover, between which a not less than 25 mm thick heat insulation material is inserted, for example, a ceramic fiber, physicochemical characteristics of which allow to provide lightness, strength and wear resistance of such a structure in high temperature operation conditions of the device, to protect the outer space from the infrared radiation and not to consume heat for heating the steam room itself. The cover of the enclosed rock compartment is tightly adjacent to the walls of the rock compartment and has an opening through which a branch pipe from the outer rock compartment passes, and to which a structure of profiled pipes is attached below, for example, of square cross section, with a series of small openings or slits in the lower part of horizontally positioned tubes of the structure. The structure of profiled pipes can be additionally rest upon, for example, brackets fixed on the inner side of the walls of the rock compartment. On the bottom of the rock compartment at least two heating elements of total power not less than 3 kW are installed, as well as a thermocouple sensor for control of the temperature in the enclosed rock compartment.

To release the fine-dispersed steam, in the cover of the enclosed rock compartment there is a series of small horizontally elongated oval slits with a jet over them, out of which, when water meets heat-retaining elements of the enclosed rock compartment, steam having passed through the convection duct casing goes out through the convection grating of the device into the steam room. The opening of the jet is turned towards the convection duct. Through the connecting pipe of the bowl of the external rock compartment water goes into the structure of profiled pipes of the enclosed rock compartment, and through openings in the profiled pipes goes on the heat-retaining elements of the enclosed rock compartment.

In the enclosed rock compartment heat-retaining elements of 25 to 30 kg can be put, which can be heated from heating elements located inside the rock compartment to a temperature up to 500° C., not loosing heat for heating the room. Due to the tight connection of the cover with the housing of the rock compartment, inside the rock compartment an excessive pressure is created, which facilitates further heating of steam and generation of fine-dispersed steam. At the temperature of the stones not less than 500° C. water instantly turns into fine-dispersed, so-called “light” steam, which allows a person to breathe freely and easily in the steam room, and it does not allow to create clouds of water saturated steam directly in the steam room. If high temperature in the enclosed rock compartment is not maintained, when saturated steam is generated a part of water remains in a droplet condition. Such steam is conventionally called “wet” or “heavy”; it causes a high amount of condensate and increases the feeling of heat in the steam room. In such a steam room the body becomes wet not having enough time to get sweat; the breath is interrupted and heavy. The same effect occurs in the case of non-sufficient heating of the steam room at the moment, when heat-retaining elements of the enclosed rock compartment are enough heated up to a temperature not less than 500° for steam generation.

The convector heater is a structure in the shape of a rectangular parallelepiped with two oppositely placed double walls, between which a heat insulation material, for example, ceramic fiber of thickness not less than 25 mm, is inserted, on the inner side of the walls an electrical insulation material, for example, a mica plate of a thickness not less than 0.5 mm, is inserted, the front wall of the convector heater has convection openings in the form of a horizontal grating for providing access into the convector for air from the steam room for its heating, the opposite rear side of the convector heater is open and tightly inserted in the opening of the convection duct casing, through which air heated up to a required temperature passes through the convection grating into the steam room. For inside protection of the opposite side of the convection duct from the infrared radiation on it, opposite the convective convector a protective screen, for example, in the form of an additional metal sheet, is installed. Inside the convector heater several heating coils are installed, depending on a required power of the device and size of the heated room, but not less than 3 kW, which are connected with the electronic control unit through a terminal block fixed on the outside of the frame structure. Heating elements and the thermocouple temperature sensor located in the enclosed rock compartment are also connected to the terminal block.

The control unit is a board on which an information output device and temperature control relay units are located. Data from the temperature sensor located in the enclosed rock compartment and from the air sensor in the steam room are sent to the control unit and demonstrated on a display, if necessary the air temperature is regulated by the relay.

The structure of the device allows to provide heating of the steam room without reducing the temperature of steam generation in the enclosed rock compartment, and vice versa, providing a required steam generation temperature in the enclosed rock compartment does not lead to the reduce of temperature in the steam room, due to providing of independent high temperature heating of heat-retaining elements of the enclosed rock compartment while maintaining a constant required air temperature in the steam room by the convector of the device to obtain fine-dispersed steam.

The technical result is creation of a structure of the device, which provides stable high-temperature conditions of heating of the heat-retaining elements of the enclosed rock compartment, at the same time maintaining by the convector of the device a constant required air temperature in the steam room for obtaining best steam generation conditions.

### BRIEF DESCRIPTION OF DRAWINGS

The essence of the invention is explained by the following drawings.

FIG. 1—General view of the device without facing boards.

FIG. 2—A module of the enclosed rock compartment with removed front and side walls without heat—retaining elements.

FIG. 3—Convective heater.

FIG. 4—Casing of the convective channel.

FIG. 5—Rear view of the device with a panel of the convective channel casing.

FIG. 6—Side view of the device with the convective channel.

FIG. 7—An enclosed rock compartment structure made out of profiled pipes.

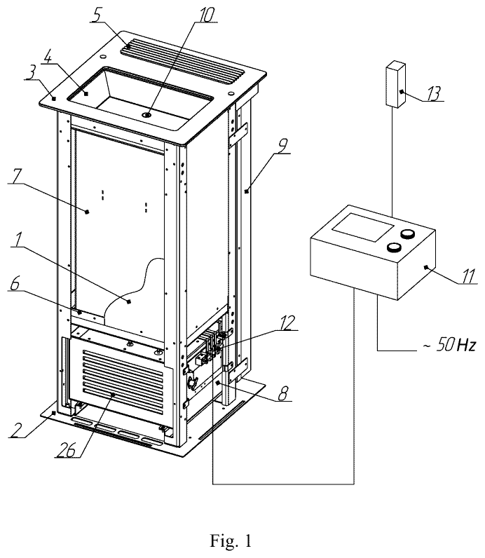

As shown in FIG. 1, the device is a frame structure with a metal housing 1 in a shape of a regular vertically oriented parallelepiped, fixed on a base 2. On a cover 3 of the device there is a bowl of an external rock compartment 4 and a convection grating 5. Inside the frame structure of the device on a metal board 6 fixed on the frame structure 1 there is an enclosed rock compartment module 7, and under the metal board 6 there is a convector heater 8. The walls of the metal housing 1 are made not to cover the area where the convector heater 8 is located. On the rear wall of the metal housing of the frame structure 1 of the device a convection duct 9 is fixed, which is closed by the convection grating 5 of the cover 3 at the top. The bowl of the external rock compartment 4 is made as a container with walls positioned at an angle to the center of the base of the bowl, to the bottom of which a connecting pipe 10 is sealed. The enclosed rock compartment module 7 and the convector heater 8 of the device are connected to an electronic control unit 11 through a terminal block 12. Also, for example, an air sensor 13 for temperature monitoring in the steam room can be connected to the electronic control unit.

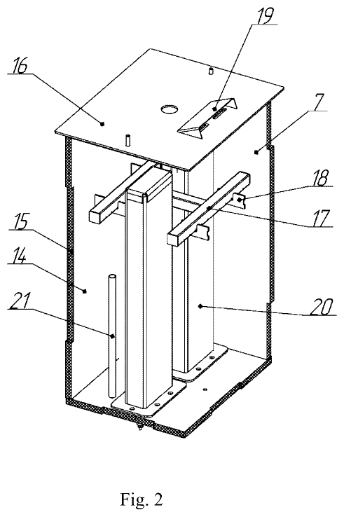

As shown in FIG. 2, the enclosed rock compartment module 7 is a metal housing, side walls and the bottom of which are assembled out of boards 14 with double walls, between which a heat insulation material 15 is inserted. The wall 16 of the enclosed rock compartment 7 is also provided with heat insulation material 15. In the connecting pipe 10, which passes into the enclosed rock compartment 7 through the opening in the cover 16, a structure 17 of profiled pipes with a series of parallel slits or small openings in the part directed downwards of horizontally positioned tubes of the structure is inserted. The structure 17 of profiled pipes can be additionally rest upon, for example, brackets 18 fixed on the inner side of the walls of the enclosed rock compartment module 7. To release the fine-dispersed steam, in the cover 16 of the enclosed rock compartment 7 there is a series of small horizontally elongated oval slits with a jet 19 over them, directed towards the casing of the convection duct 9, through which steam passes through the convection grating 5 of the cover 3 of the device into the steam room. On the bottom of the enclosed rock compartment 7 not less than two heating elements 20 in the shape of coils of current-conducting materials of total power not less than 3 KW are installed, placed in metal casings with enforcement ribs at the corners and inside the casing, the casings are filled with an electrical insulation filling, for example, electrotechnical periclase, and a thermocouple temperature sensor 21.

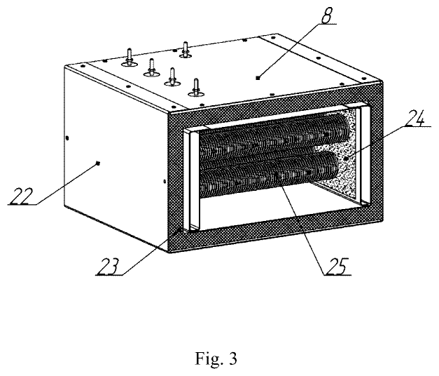

As shown in FIG. 3, the convector heater 8 is a structure in the shape of a rectangular parallelepiped with two side double walls 22, between which a heat insulation material 23 is inserted, on the inner side of the walls additionally an electrical insulation material 24 is attached, heating elements 25 being attached to said walls, the front wall of the convector heater 8 has convection openings in the form of a horizontal grating 26 for providing air access into the convector, the part of the convector heater 8 located in the opposite side is open and tightly inserted in the opening at the rear board of the convection duct 9, slightly extending over the limits of the board.

Heating elements 25 of the convector heater 8 are connected to the electronic control unit 11 through the terminal block 12, fixed outside on the frame structure 1. Heating elements 25 and the thermocouple temperature sensor 21 located in the enclosed rock compartment 7 are also connected to the terminal block 12.

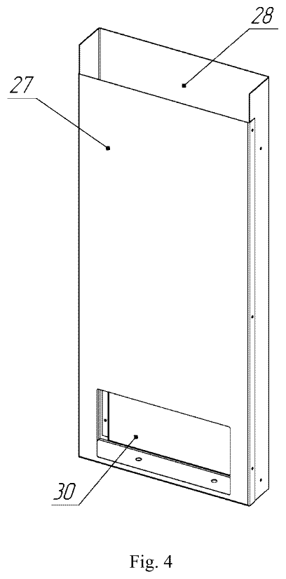

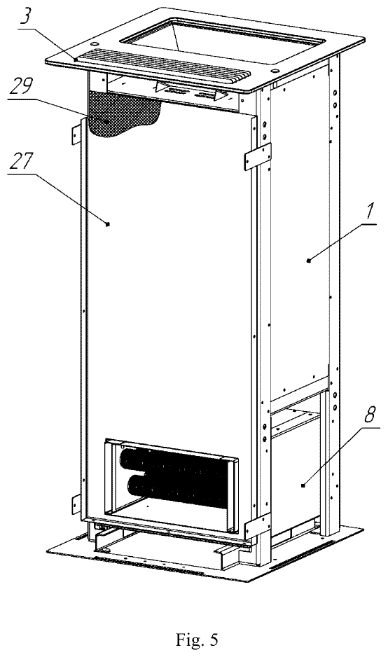

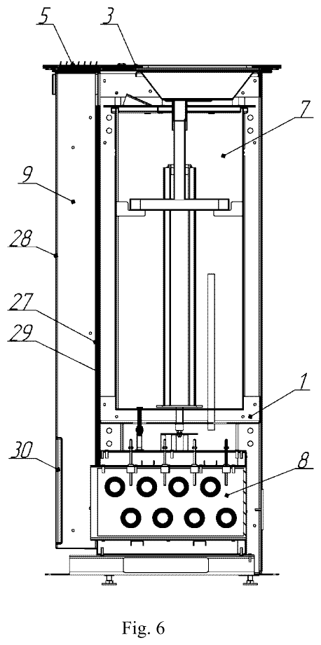

The structure of the convection duct 9 and its location in the device is demonstrated in FIG. 4, FIG. 5, FIG. 6. The casing of the convection duct 9 shown in FIG. 4 consists of a rear board 27 with small side edges bended at the right angle and a rectangular opening in its lower part corresponding to the size of the convective heater 8, which, as shown in FIG. 5, is attached to the frame structure of the device in a way to make the upper edge of the board 27 of the convection duct 9 be at the level with the cover 16 of the enclosed rock compartment 7, and of a board 28 also having side edges bended at the right angle, which is attached to the board 27 and on the top, as shown in FIG. 6, extends under the cover 3 of the device. The casing of the convection duct 9 has a bottom, formed by the lower edges of boards 27, 28. Between the casing of the convection duct 9 and the metal housing of the frame structure 1 a heat insulation material 29 is inserted. In the lower part of the internal side of the board 28, opposite the open part of the convector heater 8 a protective screen 30 is installed.

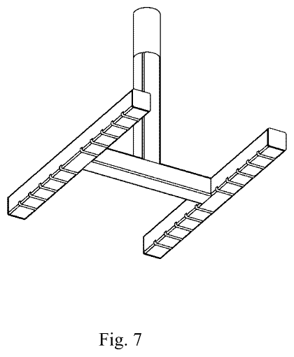

In FIG. 7 one of possible variants of the structure for even distribution of water, which is supplied through the connecting pipe 10 to the structure of shaped pipes 17 on heat-retaining elements of the enclosed rock compartment 7 through a series of parallel slits or small openings in the part directed downwards of horizontally positioned tubes of the structure, is demonstrated. The upper part of the structure of profiled pipes 17 is made in the form of a small length tube with a circular section welded to the main structure, said tube enters the connecting pipe 10.

### EMBODIMENT OF THE INVENTION

The device works as follows. The device is installed in a steam room and connected to the electronic control unit 11 through the terminal block 12, mounted in the lower side part of the frame structure 1. The control unit 11 allows to choose automatic operation modes of the device, control and adjust temperature in the enclosed rock compartment module 7 by means of the thermocouple sensor 21, in the steam room through the air sensor 13 connected to the control unit 11, and to limit operation time of the device.

The enclosed rock compartment module 7 and the bowl of the external rock compartment 4 is filled with heat-retaining material and tightly enclosed by the cover 16. To provide tight fitting of the cover 16 to the enclosed rock compartment module 7 may be additionally provided by, for example, a heat resistant cord laid along the internal diameter of the cover.

When power is supplied from the control unit by closing control power contacts of the relay at the coil of electrically conductive materials of heating elements 20 of the enclosed rock compartment 7, they are heated up to a temperature not less than 700° C., at their turn, the elements, through electrical insulation material laid in the casing of heating elements 20, heat the walls of the casing. The heat-retaining material inside the enclosed rock compartment is heated up to a temperature not less than 500° C. The thermocouple 21 located inside the enclosed rock compartment module 7 allows to control the temperature of heat-retaining elements.

Independent heating of the room is carried out in the following way. When power is supplied from the control unit by closing control power contacts of the relay at the coil of electrically conductive materials of heating elements 25 of the convector heater 8, they are heated up to a temperature not less than 250° C. The external air coming through convection openings of the grating 26 inside the convector heater 8 is heated by passing through heated coils of heating elements 25, and having become hot comes into the steam room through the convection duct 9 and openings of the convection grating 5. The temperature of the heated air in the convector heater may reach a value up to 200° C. Once the temperature of the room reaches a value required for the steam room, which is generally not more than 110° C., the sensor 13 switches off the heating of the convector.

For obtaining fine-dispersed steam, water is supplied to the bowl of the external rock compartment 4, through openings in the base of the bowl and through the steam pipe 10 water goes into the structure of profiled pipes, and through openings in the lower part of horizontally positioned tubes of the structure 17 it is evenly distributed on the heat-retaining materials of the enclosed rock compartment 7 of the device. Due to the tight connection of the cover 16 with the housing of the enclosed rock compartment 7, inside the rock compartment an excessive pressure is created, which facilitates further heating of steam and generation of fine-dispersed steam. When water meets heat-retaining elements of the enclosed rock compartment 7 heated up to a high temperature and surrounded by heated internal walls of the enclosed rock compartment, it bursts with a characteristic pop. Hot steam with droplets of water is drawn upwards, but in a closed space, when it meets a hot surface of the inner walls of the enclosed rock compartment it is additionally heated from them and from the air between heat-retaining elements while producing repeated “micro-pops”. Due to a high temperature of the heated heat accumulation elements of the enclosed rock compartment 7 water particles become smaller and smaller, and so-called “light” fine-dispersed steam is generated.

Fine-dispersed steam being under pressure inside the enclosed rock compartment 7 fly out at a high speed through the jet 19 located on the cover 16 of the enclosed rock compartment 7, and then through the convection duct 9 and openings of the convection grating 5 of the device it goes to the steam room while additionally creating a specific characteristic sound similar to that of a snowstorm. The opening of the jet is turned towards the convection duct.

The structure of the device allows to provide stable high-temperature conditions of heating of the heat-retaining elements of the enclosed rock compartment, at the same time maintaining by the convector of the device a constant required air temperature in the steam room, which allows to provide best steam generation conditions. The quality of steam obtained in the enclosed rock compartment allows a person to breathe freely and easily in the steam room, independent maintaining of temperature conditions for heating the room and for steam generation does not allow to create clouds of water saturated steam directly in the steam room.

1. An electric stove comprising:
a housing with a cover, which contains inside electric heating coils in a convector heater with heat insulated walls and a rock compartment module with heat-retaining elements, and a convection duct, wherein a housing of the convection duct is fixed on the rear wall of the housing of the stove, the convector heater inside the housing is located under the enclosed rock compartment, on the inner side of the walls of the convector heater an electrical insulation material is attached, the front wall of the convector heater has convection openings, the rear part of the convector heater extends into the opening in the rear board of the convection duct casing, on the cover of the housing of the stove there is a bowl of an external rock compartment and a convection grating, which the opening of the convection duct casing abuts, the opening in the bottom of the bowl of the external rock compartment has a connecting pipe inside, the housing of the enclosed rock compartment with the cover are protected with a heat insulation material, inside the enclosed rock compartment there are a structure of profiled pipes with a series of openings, insulated heating elements, temperature sensor, in the cover of the enclosed rock compartment there are a series of slits with a jet over them turned towards the convection duct casing, the upper edge of the rear board of the convection duct casing is at the level with the cover of the enclosed rock compartment.

2. The electric stove of claim 1, wherein the thickness of the heat insulation material of the convector heater and of the enclosed rock compartment is not less than 25 mm.

3. The electric stove of claim 1, wherein the thickness of the electrical insulation material of the convector heater is not less than 0.5 mm.

4. The electric stove of claim 1, wherein the total power of the heating coils of the convector heater is at least 3 kW.

5. The electric stove of claim 1, wherein an air sensor is connected to an electronic control unit.

6. The electric stove of claim 1, wherein the structure of profiled pipes of the enclosed rock compartment rests upon brackets fixed on the inner side of the walls of the enclosed rock compartment module.

7. The electric stove of claim 1, wherein the total power of heating elements of the enclosed rock compartment is at least 3 kW.

8. The electric stove of claim 1, wherein inside the rock compartment the heating elements are placed in metal casings with enforcement ribs at the corners and inside the casing, the casings are filled with an electrical insulation filling.

9. The electric stove of claim 1, wherein the enclosed rock compartment module and the convector heater are connected to the electronic control unit.

10. The electric stove of claim 1, wherein in the convection duct casing, opposite the convector heater, a protective screen is installed.

11. The electric stove of claim 1, wherein between the rear board of the convection duct casing and the housing a heat insulation material is inserted.
